(19) United States
(12) Patent Application Publication
(10) Pub. No.: US 2026/0260362 A1
(43) Pub. Date: Sep. 3, 2026

(54) INFORMATION PROCESSING APPARATUS, INFORMATION PROCESSING METHOD, AND INFORMATION PROCESSING SYSTEM

(71) Applicant: SONY GROUP CORPORATION, TOKYO (JP)

(72) Inventors: TAKURO ENOMOTO, TOKYO (JP); TETSUO KANEKO, TOKYO (JP)

(21) Appl. No.: 19/491,256

(22) PCT Filed: Jun. 19, 2024
(86) PCT No.: PCT/JP2024/022162

§ 371 Date: Dec. 8, 2025

(30) Foreign Application Priority Data
Jun. 29, 2023 (JP) 2023-107310

(51) Int. Cl. G06T 7/246; G06T 7/73; H04N 23/695

(52) U.S. Cl. CPC G06T 7/246; G06T 7/73; H04N 23/695; G06T 2207/30196

(57) ABSTRACT

An information processing apparatus includes an acquisition unit that acquires an image obtained by an imaging device and focus information regarding a focus when the image is imaged, and a tracking processing unit that performs camera tracking processing on the image by using the focus information.

### TECHNICAL FIELD

The present technology relates to an information processing apparatus, an information processing method, and an information processing system, and particularly relates to a camera tracking technology.

### BACKGROUND ART

In related art, so-called camera tracking in which a feature point is extracted from a moving image obtained by an imaging device and a position and a posture of a camera are estimated on the basis of the extracted feature point is performed (see, for example, Patent Document 1).

### CITATION LIST

### Patent Document

Patent Document 1: Japanese Patent Application Laid-Open No. 2011-118724

### SUMMARY OF THE INVENTION

### Problems to be Solved by the Invention

Incidentally, in the camera tracking, when a feature point is extracted from a moving body, it is not possible to distinguish whether the feature point is moved due to movement of the moving body or the feature point is moved due to movement of the imaging device 2, and accuracy of tracking processing is reduced.

Therefore, it is conceivable to distinguish between a moving body or a non-moving body for every subject in the image by performing image processing before the feature point is extracted, and extract the feature point from the subject distinguished as the non-moving body.

However, in this method, since image processing for distinguishing between the moving body and the non-moving body is performed, there is a problem that a processing time becomes long.

The present technology has been made in view of the above circumstances, and an object thereof is to improve accuracy of tracking processing while reducing a processing time.

### Solutions to Problems

An information processing apparatus according to the present technology includes an acquisition unit that acquires an image obtained by an imaging device and focus information regarding a focus when the image is imaged; and a tracking processing unit that performs camera tracking processing on the image by using the focus information.

Therefore, the information processing apparatus can accurately extract the feature point used for the camera tracking processing on the basis of the focus information.

### BRIEF DESCRIPTION OF DRAWINGS

FIG. 1 is a diagram illustrating a configuration of an information processing system as an embodiment according to the present technology.

FIG. 2 is a diagram illustrating a configuration of an imaging device.

FIG. 3 is a block diagram illustrating internal configurations of the imaging device and an interchangeable lens.

FIG. 4 is a block diagram illustrating a configuration of a computer.

FIG. 5 is a functional block diagram of a control unit.

FIG. 6 is a diagram for explaining a data structure of an image file obtained by the imaging device.

FIG. 7 is a diagram for explaining camera tracking processing.

FIG. 8 is a diagram for explaining extraction of a feature point in a case where a person is detected as a moving body.

FIG. 9 is a diagram for explaining extraction of a feature point in a case where an animal is detected as a moving body.

FIG. 10 is a diagram for explaining extraction of a feature point in a case where a subject designated by a user is an animal.

FIG. 11 is a diagram for explaining a motion of the imaging device.

FIG. 12 is a flowchart illustrating a flow of the tracking processing.

FIG. 13 is a diagram for explaining weighting.

FIG. 14 is a flowchart illustrating a flow of the tracking processing.

FIG. 15 is a functional block diagram of a control unit in a third example.

### MODE FOR CARRYING OUT THE INVENTION

Hereinafter, embodiments will be described in the following order.
<1. Information Processing System>
<2. Autofocus Processing>
<3. Camera tracking Processing>
<4. Modifications>
<5. Summary of Embodiment>
<6. Present Technology>

Note that, in the present technology, an “image” indicates a moving image. Furthermore, the “image” refers not only to a state where the image is displayed on a display unit, but also image data in a state where the image is not displayed on the display unit may be referred to as an “image”.

A “subject” refers not only to a target to be imaged by an imaging device but also includes a subject image appearing in an image. Furthermore, the “subject” includes not only a person but also various objects such as an animal, a bird, an insect, a car, a train, a road, and a building, and further includes a part (portion) of these objects.

### 1. Information Processing System

### [1.1. Configuration of Information Processing System]

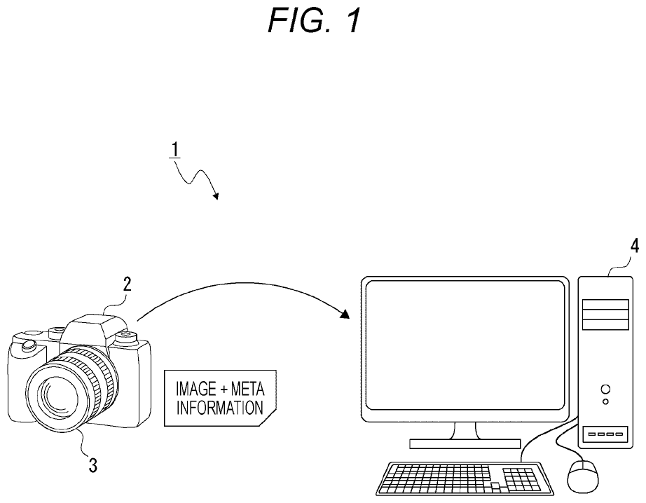

FIG. 1 is a diagram illustrating a configuration of an information processing system 1 as an embodiment according to the present technology. As illustrated in FIG. 1, the information processing system 1 includes an imaging device 2 and a computer 4.

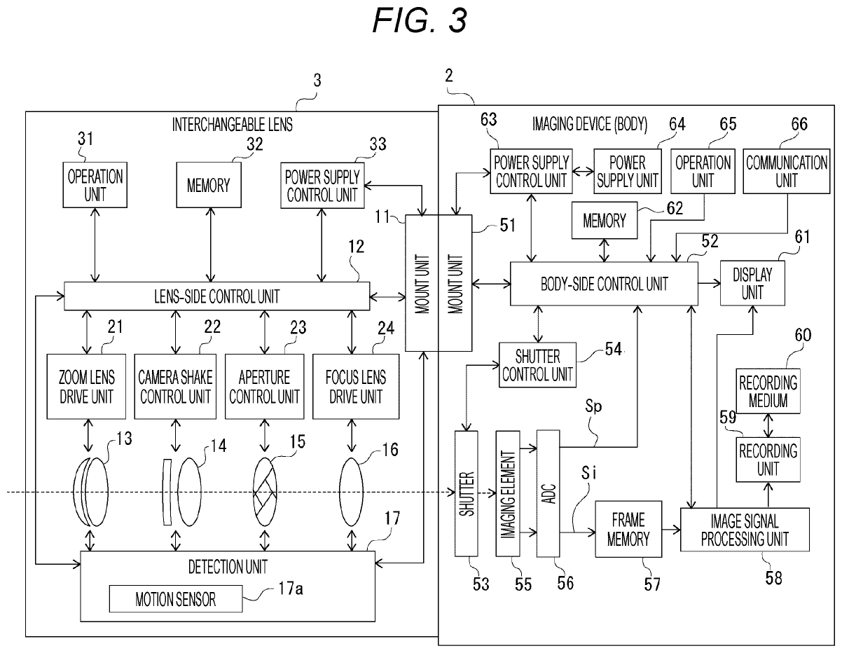

The imaging device 2 can add meta information to an image (moving image) obtained by imaging a subject image incident via an interchangeable lens 3 including a focus lens 16 (see FIG. 3).

Here, “adding” means that the meta information can be used when image editing processing is executed on the image. Accordingly, when the meta information is added to the image, the image and the meta information may be recorded as one file or the like in a recording medium, or may be transmitted to another device (computer 4). Furthermore, the image and the meta information may be recorded in different recording media (or different recording areas of the same recording medium), or may be separately transmitted to another device (computer 4).

The computer 4 is, for example, a personal computer, a mobile terminal device, a tablet terminal device, or the like, and can acquire the image and the meta information from the imaging device 2.

Furthermore, the computer 4 may be a server or the like that performs cloud computing. In this case, the computer 4 acquires the image and the meta information from the imaging device 2 via a network.

The computer 4 performs camera tracking processing and the like as described in detail later.

The camera tracking processing is processing of estimating (calculating) a motion (position and posture) of the imaging device 2 on the basis of the image imaged by the imaging device 2 and estimating a 3D spatial structure in the image.

### [1.2. Configuration of Imaging Device]

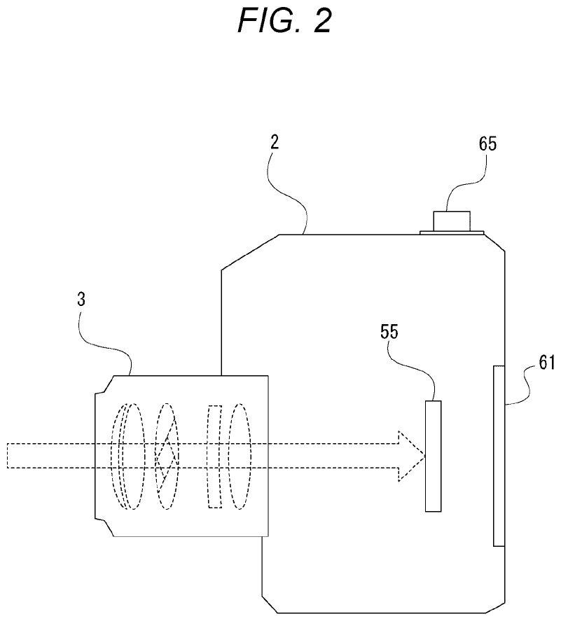

FIG. 2 is a diagram illustrating a configuration of the imaging device 2.

The imaging device 2 (body) is a digital camera device to which the interchangeable lens 3 is detachably attached. The imaging device 2 may have not only an imaging function of a moving image but also an imaging function of a still image. Note that, although the interchangeable lens 3 is detachably attached to the imaging device 2, the interchangeable lens 3 may not be detachably attached to the imaging device 2.

As illustrated in FIG. 2, the imaging device 2 includes an imaging element 55 that images a subject image incident via the interchangeable lens 3, a display unit 61 capable of displaying an imaged image obtained by the imaging element 55 and GUIs such as various operation screens, an operation unit 65 for a user to perform various operation inputs, and the like.

Furthermore, the imaging device 2 includes, for example, a configuration for recording the imaged image by the imaging element 55, a configuration for performing image signal processing on the imaged image by the imaging element 55, a configuration for performing communication with the interchangeable lens 3, and the like.

The interchangeable lens 3 is a lens unit in which various lenses such as a focus lens and a zoom lens are provided. Furthermore, the interchangeable lens 3 includes a drive unit that drives these lenses, a control unit that outputs a drive signal to the drive unit, a mount unit having a connection function and a communication function with respect to the imaging device 2, and the like.

FIG. 3 is a block diagram illustrating internal configurations of the imaging device 2 and the interchangeable lens 3.

As illustrated in FIG. 3, the interchangeable lens 3 includes a mount unit 11 detachably attached to the mount unit 51 of the imaging device 2. The mount unit 11 has a plurality of terminals for electrical connection with the imaging device 2.

Furthermore, the interchangeable lens 3 includes a lens-side control unit 12, a zoom lens 13, a camera shake correction lens 14, an aperture 15, a focus lens 16, a detection unit 17, an operation unit 31, a memory 32, and a power supply control unit 33.

Moreover, the interchangeable lens 3 includes a zoom lens drive unit 21, a camera shake control unit 22, an aperture control unit 23, and a focus lens drive unit 24.

The lens-side control unit 12 includes, for example, a microcomputer including a central processing unit (CPU), a read only memory (ROM), a random access memory (RAM), and the like, and performs overall control of the interchangeable lens 3 by the CPU reading a program stored in a predetermined storage device such as the ROM or the memory 32 into the RAM and executing the program.

For example, the lens-side control unit 12 controls a position of the zoom lens 13 on the basis of an instruction from the imaging device 2 supplied via a predetermined communication terminal of the mount unit 11 or an operation of the user received by the operation unit 31.

Specifically, the lens-side control unit 12 acquires a current position of the zoom lens 13 detected by the detection unit 17 including, for example, a magnetic sensor (MR sensor). Then, the lens-side control unit 12 determines a driving direction and a driving amount for moving the zoom lens 13 to a predetermined position on the basis of an acquisition result, and outputs, together with a movement command, the determined driving direction and driving amount to the zoom lens drive unit 21.

The zoom lens drive unit 21 moves the zoom lens 13 in an optical axis direction so as to achieve the instructed driving direction and driving amount on the basis of the movement command supplied from the lens-side control unit 12.

Here, the detection unit 17 comprehensively represents a configuration for detecting a state of the interchangeable lens 3, such as positions of the zoom lens 13, the camera shake correction lens 14, and the focus lens 16, and an opening diameter of the aperture 15. In the detection unit 17, the positions of the lenses can be detected by, for example, a magnetic sensor, a photodiode array, a potentiometer, a reflective encoder, or the like.

Furthermore, the detection unit 17 includes a motion sensor 17a. The motion sensor 17a detects the motion of the imaging device 2. Specifically, the motion sensor 17a includes an acceleration sensor that detects accelerations in three axial directions orthogonal to each other including the optical axis direction, and a gyro sensor that detects angular velocities (pitch, yaw, and roll) around three axes.

The motion sensor 17a detects, for example, accelerations and angular velocities in synchronization with (at the same interval as) a frame constituting the moving image obtained by the imaging device 2.

The lens-side control unit 12 performs processing of transmitting, as motion information, the acceleration and the angular velocity detected by the motion sensor 17a to the imaging device 2.

The lens-side control unit 12 controls the camera shake correction lens 14 to correct camera shake. Specifically, on the basis of a motion amount (camera shake amount) of the imaging device 2 detected by the motion sensor 17a, the lens-side control unit 12 determines a driving direction and a driving amount of the camera shake correction lens 14 in a direction to cancel the camera shake amount, and outputs, together with a movement command, the determined driving direction and driving amount to the camera shake control unit 22.

The camera shake control unit 22 moves the camera shake correction lens 14 in the instructed driving direction and driving amount on the basis of the movement command supplied from the lens-side control unit 12.

Furthermore, in a case where the supply of power is turned off, the lens-side control unit 12 performs control to mechanically lock the camera shake correction lens 14. In a state where the power is supplied from the imaging device 2 to the interchangeable lens 3, a position of the camera shake correction lens 14 is maintained at a predetermined position by control via the camera shake control unit 22. On the other hand, when the supply of the power is turned off, since the position control by the camera shake control unit 22 is stopped, the camera shake correction lens 14 falls by a predetermined amount in a gravity direction.

Thus, the lens-side control unit 12 mechanically locks the camera shake correction lens 14 via the camera shake control unit 22 in accordance with a timing at which the supply of the power is turned off, and thus, the camera shake correction lens 14 is prevented from falling. The camera shake control unit 22 mechanically locks the camera shake correction lens 14 on the basis of a fixing command supplied from the lens-side control unit 12.

Furthermore, the lens-side control unit 12 controls (the opening diameter of) the aperture 15 in accordance with an instruction or the like from the imaging device 2 supplied via a predetermined communication terminal of the mount unit 11. Specifically, the lens-side control unit 12 acquires the opening diameter of the aperture 15 detected by an aperture detection sensor in the detection unit 17, issues a command to the aperture control unit 23 so as to achieve an F-value instructed by the imaging device 2, and drives the aperture 15. The aperture control unit 23 drives the aperture 15 to have the opening diameter instructed from the lens-side control unit 12.

Moreover, the lens-side control unit 12 controls the position of the focus lens 16 on the basis of an instruction from the imaging device 2 supplied via a predetermined communication terminal of the mount unit 11.

Here, for example, in autofocus processing, a target focus lens position is instructed from the imaging device 2 to the lens-side control unit 12.

The lens-side control unit 12 acquires a current position of the focus lens 16 from the detection unit 17, and determines a driving direction and a driving amount for moving the focus lens 16 to a target position on the basis of the acquired current position and the target focus lens position instructed from the imaging device 2. Then, the lens-side control unit 12 outputs, together with the movement command, the determined driving direction and driving amount to the focus lens drive unit 24.

The focus lens drive unit 24 moves the focus lens 16 in the optical axis direction so as to achieve the instructed driving direction and driving amount.

Here, the focus lens 16 is a “focus lens group” including one or a plurality of optical elements. In a case where the focus lens group includes a plurality of optical elements, the optical elements are integrally displaced with focus adjustment.

Note that, such a point similarly applies to the zoom lens 13. That is, the zoom lens 13 is a “zoom lens group” including one or a plurality of optical elements, and in a case where the zoom lens group includes a plurality of optical elements, the optical elements are integrally displaced with zoom adjustment.

In this example, each of the zoom lens 13 and the focus lens 16 includes one zoom lens group and one focus lens group. However, each of the zoom lens 13 and the focus lens 16 may include a plurality of zoom lens groups and a plurality of focus lens groups.

The Focus Lens Drive Unit 24 Can Include, As a drive source of the lens, for example, an ultrasonic motor, a DC motor, a linear actuator, a stepping motor, a piezo element (piezoelectric element), and the like.

Note that, the focus adjustment can be configured to be performed in accordance with the operation of the user received by the operation unit 31.

The memory 32 is a non-volatile memory such as an Electrically Erasable Programmable ROM (EEPROM), for example, and can be used to store an operation program of the lens-side control unit 12 and various types of data.

The power supply control unit 33 detects a power amount of the power supplied from the imaging device 2, optimally distributes the power amount to each unit (the lens-side control unit 12 and various drive units) in the interchangeable lens 3 on the basis of the detected power amount, and supplies the power.

The mount unit 51 to which the interchangeable lens 3 is detachably attached is provided in the imaging device 2 on the body side. The mount unit 51 has a plurality of terminals for electrical connection with the mount unit 11 of the interchangeable lens 3.

When the interchangeable lens 3 is mounted on the mount unit 51 of the imaging device 2, the corresponding terminals are electrically and physically connected between the mount unit 51 and the mount unit 11 of the interchangeable lens 3. Examples of the terminal to be connected include a terminal for supplying power (power supply terminal), a terminal for transmitting a command or data (communication terminal), and a terminal for transmitting a synchronization signal (synchronization signal terminal).

Furthermore, the imaging device 2 includes a body-side control unit 52, a shutter 53, a shutter control unit 54, the imaging element 55, an analog to digital converter (ADC) 56, a frame memory 57, an image signal processing unit 58, a recording unit 59, a recording medium 60, the display unit 61, a memory 62, a power supply control unit 63, a power supply unit 64, the operation unit 65, and a communication unit 66.

The power supply control unit 63 supplies power supplied from the power supply unit 64 to each unit of the imaging device 2 including the body-side control unit 52. Furthermore, the power supply control unit 63 calculates a power amount of the power that can be Supplied to the interchangeable lens 3 on the basis of an operation state of the imaging device 2, and supplies the power to the interchangeable lens 3 via the mount unit 51.

The power supply unit 64 includes, for example, a secondary battery such as a NiCd battery, a NiMH battery, or a Li battery. Note that, the power supply unit 64 can be configured to be able to receive power from a commercial AC power supply via an AC adapter or the like.

The body-side control unit 52 includes a microcomputer including a CPU, a ROM, a RAM, and the like, and performs overall control of the imaging device 2 and the interchangeable lens 3 by the CPU reading a program stored in a predetermined storage device such as the ROM or the memory 62 into the RAM and executing the program.

The memory 62 is a non-volatile memory such as an EEPROM, for example, and can be used for storing an operation program of the body-side control unit 52 and various types of data.

The body-side control unit 52 causes the imaging element 55 to execute imaging processing on the basis of an operation signal indicating an operation of the user supplied from the operation unit 65. Moreover, a predetermined command is transmitted to the interchangeable lens 3 side via the mount unit 51, and the focus lens 16, the zoom lens 13, and the like are driven.

The shutter 53 is disposed on a front surface (subject side) of the imaging element 55, and is opened and closed under the control of the shutter control unit 54. When the shutter 53 is in a closed state, light of the subject passing through an optical system of the interchangeable lens 3 is blocked. The shutter control unit 54 detects an open or closed state of the shutter 53 and supplies information indicating the detection result to the body-side control unit 52. The shutter control unit 54 drives the shutter 53 to the open state or the closed state on the basis of the control of the body-side control unit 52.

The imaging element 55 is, for example, an image sensor including a charge coupled device (CCD) sensor, a complementary metal oxide semiconductor (CMOS) sensor, or the like, and outputs a light reception signal obtained by imaging a subject.

In a case where the imaging element 55 includes a CCD sensor or a CMOS sensor, an electronic shutter can be used, and thus, the shutter 53 can be omitted. In a case where the shutter 53 is omitted, the shutter control unit 54 used for the control is also omitted.

Furthermore, the imaging element 55 includes pixels (RGB pixels) for imaging an image, and pixels for acquiring detection information used for AF processing by an image-plane phase difference method, that is, phase difference detection pixels that include a pair of photoelectric conversion units (diodes) on which pupil-divided light is incident on one pixel and detect a phase difference between a pair of images generated by the pair of photoelectric conversion units.

In the imaging element 55, the RGB pixels are, for example, two-dimensionally arrayed in the horizontal direction and the vertical direction in a predetermined array pattern such as a Bayer array. In the imaging element 55, the phase difference detection pixels are discretely arranged in the horizontal direction and the vertical direction on a pixel array surface in which RGB pixels are two-dimensionally arranged.

A light reception signal obtained by photoelectric conversion of the RGB pixel in the imaging element 55 is converted into a digital signal by the ADC 56, temporarily retained in the frame memory 57, and then input to the image signal processing unit 58.

In FIG. 3, an imaged image signal obtained by digitally converting the light reception signal of the RGB pixel as described above is referred to as an “imaged image signal Si”.

On the other hand, a light reception signal obtained by photoelectric conversion of the phase difference detection pixel in the imaging element 55 is converted into a digital signal by the ADC 56 and supplied to the body-side control unit 52.

In FIG. 3, the signal obtained by the digital conversion of the light reception signal of the phase difference detection pixel is expressed as a “phase difference pixel signal Sp”.

The body-side control unit 52 detects a phase difference (phase shift amount) between a pair of images on the basis of the phase difference pixel signal Sp supplied via the ADC 56, and thus, a focus shift amount for every phase difference detection pixel, that is, a defocus amount is calculated as phase difference information. Note that, since an existing method can be used as a method for calculating the defocus amount, a detailed description thereof will be omitted.

The body-side control unit 52 can perform autofocus processing on the basis of the phase difference information calculated in this manner. In the phase difference detection pixel, for example, a light reception signal is obtained in synchronization with the RGB pixel. That is, the body-side control unit 52 calculates the phase difference information in synchronization with (at the same interval as) the frame constituting the moving image obtained by the imaging device 2.

The image signal processing unit 58 performs predetermined image signal processing on the imaged image based on the imaged image signal Si input via the frame memory 57. Examples of the image signal processing here include demosaic processing, white balance (WB) adjustment, gamma correction processing, and the like.

After performing image signal processing on the imaged image, the image signal processing unit 58 converts the imaged image into a predetermined file format and causes the imaged image to be recorded on the recording medium 60 via the recording unit 59.

At this time, as described in detail later, the body-side control unit 52 adds meta information to an image recorded on the recording medium 60.

Furthermore, the image signal processing unit 58 supplies the image after the image signal processing to the display unit 61, and causes the imaged image to be displayed on the display unit 61.

The recording medium 60 includes a non-volatile memory, and the recording unit 59 is configured to be able to write data to the recording medium 60 and read data recorded in the recording medium 60. Here, the recording medium 60 may be detachably attached to the imaging device 2.

The display unit 61 includes a display device such as a liquid crystal display or an organic EL display, and can display an image.

The display unit 61 is mounted on a back surface opposite to a front surface of the imaging device 2 on which the mount unit 51 is disposed, and can perform display of a so-called through image, display of an image read from the recording medium 60, display of a GUI as various operation screens, and the like. Note that, the display unit 61 may be mounted on a portion other than the back surface.

The operation unit 65 comprehensively represents an operation element for the user to perform an operation input to the imaging device 2, such as, for example, various hardware keys such as a shutter button, a mode dial, and a zoom button, and a touch panel provided to be able to detect a touch operation on a display screen of the display unit 61.

The operation unit 65 receives an operation of the user and supplies an operation signal corresponding to the operation to the body-side control unit 52.

The communication unit 66 performs wired or wireless communication with an external device.

### [1.3. Configuration of Computer]

Next, a configuration of the computer 4 will be described.

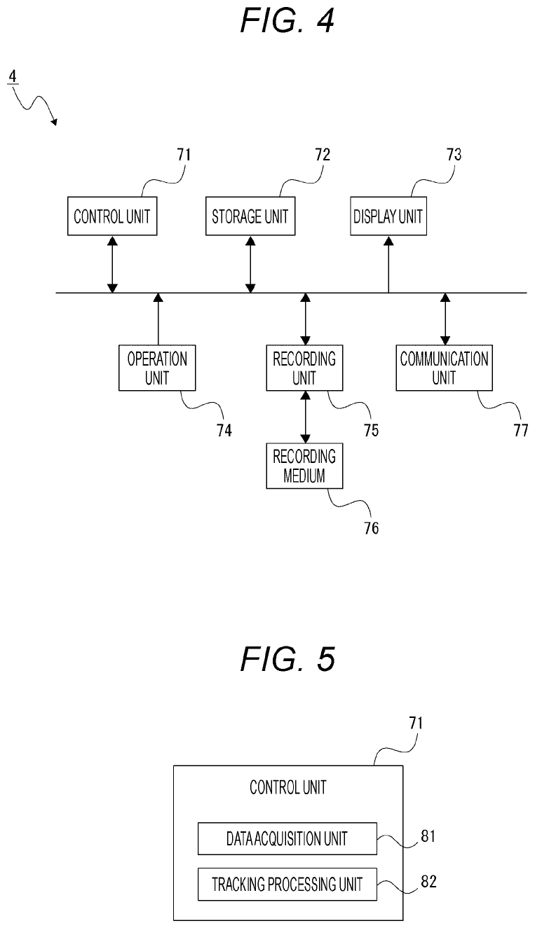

FIG. 4 is a block diagram illustrating the configuration of the computer 4. As illustrated in FIG. 4, the computer 4 includes a control unit 71, a storage unit 72, a display unit 73, an operation unit 74, a recording unit 75, a recording medium 76, and a communication unit 77.

The control unit 71 includes, for example, a microcomputer including a CPU, a ROM, a RAM, and the like, and performs overall control of the computer 4 by the CPU reading a program stored in a predetermined storage device such as the ROM or the storage unit 72 into the RAM and executing the program.

The storage unit 72 includes, for example, a storage medium such as a solid-state memory. The storage unit 72 can store various types of information.

Furthermore, the storage unit 72 can be used for storing program data for the control unit 71 to execute various types of processing.

The display unit 73 is a liquid crystal display, an organic EL display, or the like, and displays various images.

The operation unit 74 is an input device used by the user, and is, for example, various operation elements and operation devices such as a keyboard, a mouse, a button, a dial, a touch pad, and a touch panel. When the user operation is detected by the operation unit 74, a signal corresponding to the input operation is input to the control unit 71.

The recording medium 76 includes a non-volatile memory, and the recording unit 75 is configured to be able to write data to the recording medium 76 and read data recorded in the recording medium 76. Here, the recording medium 76 may be detachably attached to the computer 4.

The communication unit 77 performs wired or wireless communication with an external device.

FIG. 5 is a functional block diagram of the control unit 71. As illustrated in FIG. 5, the control unit 71 includes functional units as a data acquisition unit 81 and a tracking processing unit 82.

In a case where the recording medium 60 of the imaging device 2 is mounted as the recording medium 76 on the computer 4, the data acquisition unit 81 acquires an image and meta information from the recording medium 76 via the recording unit 75. Furthermore, the data acquisition unit 81 may acquire the image and the meta information by communicating with the imaging device 2 via the communication unit 77.

The tracking processing unit 82 executes camera tracking processing on the image acquired by the data acquisition unit 81 while referring to the meta information.

Note that, the camera tracking processing executed by the tracking processing unit 82 will be described later in detail.

### 2. Autofocus (AF) Processing

Next, autofocus processing executed by the imaging device 2 will be described.

The body-side control unit 52 detects a predetermined subject from the image and executes autofocus processing of focusing on the detected subject. Furthermore, in the autofocus processing, for example, the body-side control unit 52 can execute processing of tracking a subject once focused as a tracking target and continuing focusing.

Here, a type of the subject to be detected in the autofocus processing is determined in advance, and examples thereof include living things such as persons and animals, and vehicles such as cars and trains.

Furthermore, in the subject to be detected, a portion of the subject that can be detected is determined. For example, in the case of the person, the subject is a skeleton, a face, a body, or the like.

The body-side control unit 52 detects the subject by detection processing. The detection processing is performed by using, for example, an algorithm trained by deep learning such as convolutional neural network (CNN).

In the imaging device 2, an algorithm trained in advance by deep learning or the like is stored in the memory 62.

In a case where the moving image is imaged, the body-side control unit 52 detects the subject by using the algorithm stored in the memory 62 for every frame.

Then, when the subject is detected, the body-side control unit 52 performs autofocus control to focus on the subject.

Note that, in the detection processing, a plurality of subjects can be detected for an image of one frame.

Then, the body-side control unit 52 determines whether or not the subject detected by the detection processing is moving by tracking the subject between frames. That is, the body-side control unit 52 determines whether or not the subject detected by the detection processing is a moving body.

For example, the body-side control unit 52 may determine that the detected subject is the moving body in a case where the detected subject is moving in either the vertical direction or the horizontal direction between frames. Furthermore, the body-side control unit 52 may determine that the subject is the moving body in a case where the detected subject is moving in a depth direction between frames on the basis of the focus shift amount calculated by the phase difference detection pixel corresponding to the position of the subject.

For every subject determined to be the moving body, the body-side control unit 52 adds focus information indicating the position of the subject to the image by including the focus information in the meta information. Note that, in the focus information, the position of the subject (coordinates on the image) is indicated by a point or a range. Furthermore, the focus information is information regarding the focus and is generated for every frame.

Furthermore, when a predetermined position is selected by the user from the through image displayed on the display unit 61, the body-side control unit 52 can execute image processing to detect a subject selected by the user, and perform autofocus control to focus on the subject.

Even in this case, for the subject selected by the user, the body-side control unit 52 adds focus information indicating the position of the subject to the image by including the focus information in the meta information.

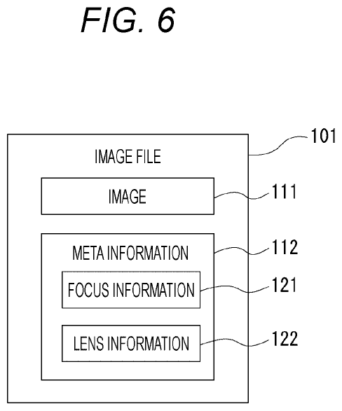

FIG. 6 is a diagram for explaining a data structure of an image file obtained by the imaging device 2. As illustrated in FIG. 6, in the imaging device 2, in a case where the subject is imaged, an image file 100 including an image 111 and meta information 112 is generated. The meta information 112 can include focus information 121 and lens information 122 regarding the lens of the imaging device 2 such as a focal length, a focus position, an aperture value, and lens distortion information.

Note that, the image file 100 may include common audio data.

### 3. Camera Tracking Processing

### [3.1. First Example of Camera Tracking Processing]

Next, a first example of camera tracking processing performed by the computer 4 will be described.

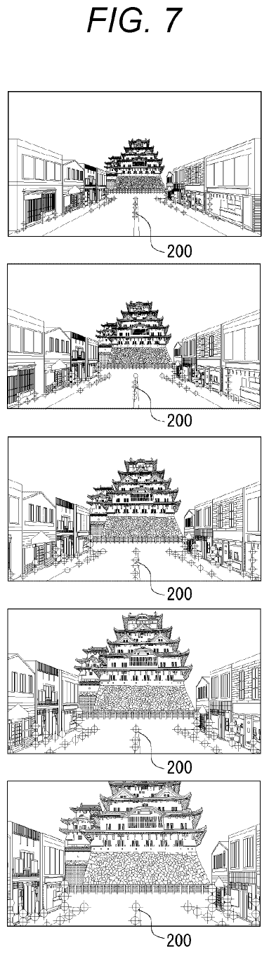

FIG. 7 is a diagram for explaining the camera tracking processing. In FIG. 7, frames constituting an image (moving image) are illustrated in chronological order from top to bottom.

The tracking processing unit 82 performs camera tracking processing on the image 111 by using the focus information 121, and detects the motion (position and posture) of the imaging device 2.

Specifically, the tracking processing unit 82 extracts a plurality of feature points for every frame constituting the image as indicated by a marker 200 in FIG. 7. The feature point is determined by, for example, edge processing or the like with respect to the same subject portion among a plurality of frames.

At this time, when the feature point is extracted from the moving body, it is not possible to distinguish whether the feature point is moved due to the movement of the moving body or the feature point is moved due to the movement of the imaging device 2, and the accuracy of the tracking processing is reduced.

Therefore, in the camera tracking processing of the first example, the tracking processing unit 82 performs mask processing of masking a range including the position of the subject detected as the moving body in the image 111 while referring to the focus information 121.

Then, the tracking processing unit 82 extracts a feature point from a region excluding the masked range in the image 111.

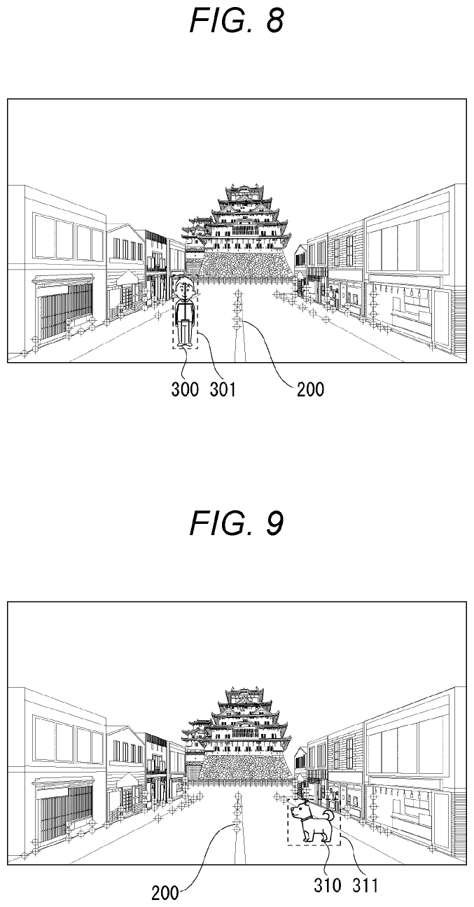

FIG. 8 is a diagram for explaining the extraction of the feature point in a case where the person is detected as the moving body. As illustrated in FIG. 8, it is assumed that a person 300 is detected as the moving body and a position of the person 300 is indicated by the focus information 121.

In this case, the tracking processing unit 82 masks a range 301 including the position of the person 300 indicated by the focus information. Here, for example, in a case where the position of the person 300 is indicated by a plurality of pieces of skeleton information, the tracking processing unit 82 sets a range 301 surrounding a position indicated by the plurality of pieces of skeleton information. Then, the tracking processing unit 82 masks the range 301.

The tracking processing unit 82 extracts a feature point from a region excluding the masked range 301 in the image 111. Therefore, the feature point is not extracted from the masked range 301.

FIG. 9 is a diagram for explaining the extraction of the feature point in a case where an animal (dog) is detected as the moving body. As illustrated in FIG. 9, it is assumed that an animal 310 is detected as the moving body and a position of the animal 310 is indicated as a range 311 by the focus information 121. In this case, the tracking processing unit 82 masks the range 311 indicated by the focus information 121.

The tracking processing unit 82 extracts a feature point from a region excluding the masked range 311.

Therefore, the feature point is not extracted from the masked range 311.

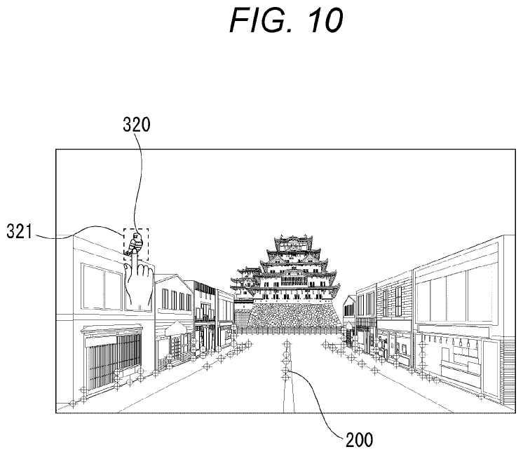

FIG. 10 is a diagram for explaining the extraction of the feature point in a case where the subject designated by the user is an animal (bird). As illustrated in FIG. 10, it is assumed that an animal 320 designated by the user is detected and a position of the animal 320 is indicated as a range 321 by the focus information 121. In this case, the tracking processing unit 82 masks the range 321 indicated by the focus information 121.

The tracking processing unit 82 extracts a feature point from a region excluding the masked range 321. Therefore, the feature point is not extracted from the masked range 321.

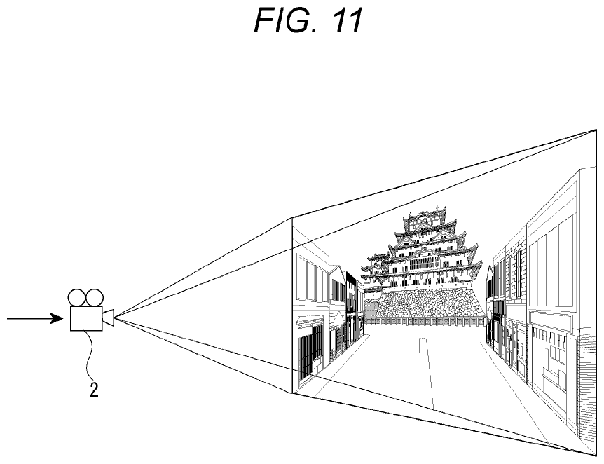

FIG. 11 is a diagram for explaining the motion of the imaging device 2. Note that, in FIG. 11, a movement trajectory of the imaging device 2 is indicated by an arrow.

Then, the tracking processing unit 82 estimates the 3D spatial structure in the image by recording a motion, in a time direction, of the feature point of the same subject portion extracted for every frame image and performing geometric calculation. Note that, a known method can be used as the calculation method here, and thus, detailed description thereof will be omitted.

Furthermore, as illustrated in FIG. 11, the tracking processing unit 82 estimates the movement (XYZ direction) of the imaging device 2 and the posture (Pan, Tilt, and Roll directions) of the imaging device 2 in the estimated 3D spatial structure.

As described above, in the computer 4, the moving body is masked on the basis of the focus information 121 obtained by the imaging device 2, and thus, it is possible to reduce the extraction of the feature point from the moving body, and to accurately execute the camera tracking processing.

Furthermore, in the computer 4, since it is not necessary to execute the processing for distinguishing between the moving body and a non-moving body, it is possible to shorten a processing time of the camera tracking processing.

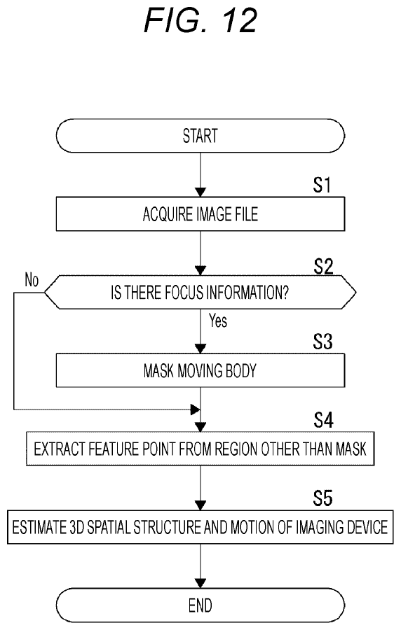

FIG. 12 is a flowchart illustrating a flow of tracking processing. As illustrated in FIG. 12, when the tracking processing is started, the data acquisition unit 81 acquires the image file 100 from the imaging device 2 in step S1.

In subsequent step S2, the tracking processing unit 82 determines whether or not the acquired image file 100 includes the focus information 121. In a case where the focus information 121 is included in the image file 100 (Yes in step S2), the tracking processing unit 82 masks a range including a subject detected as the moving body for the image 111 on the basis of the focus information 121.

Note that, in a case where the focus information 121 is not included in the image file 100 (No in step S2), the tracking processing unit 82 shifts the processing to step S4 without masking the image 111.

In step S4, the tracking processing unit 82 extracts a feature point from an unmasked region in the image 111. In step S5, the tracking processing unit 82 estimates the 3D spatial structure in the image and the motion of the imaging device 2, and ends the tracking processing.

### [3.2. Second Example of Tracking Processing]

In the tracking processing of the first example, the tracking processing unit 82 extracts a feature point from a region other than the masked range. Therefore, the feature point is not extracted in the masked range.

On the other hand, in the tracking processing of the second example, the feature point is extracted even in the masked range. On the other hand, when the 3D spatial structure and the motion of the imaging device 2 are estimated, weighting of the feature point in the masked range is reduced to reduce a contribution degree to the estimation.

Specifically, similarly to the first example, the tracking processing unit 82 performs mask processing of masking the range including the subject detected as the moving body in the image while referring to the focus information 121.

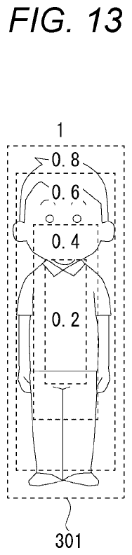

FIG. 13 is a diagram for explaining weighting. The tracking processing unit 82 estimates the 3D spatial structure in the image and the motion of the imaging device 2 by recording the motion, in the time direction, of the feature point extracted for every frame image and performing the geometric calculation.

At this time, for example, as illustrated in FIG. 13, a weighting coefficient of less than 1 is assigned to the masked range 301. More specifically, in the masked range 301, the closer to a center, the smaller value the weighting coefficient is assigned, and the farther from the center, the larger value the weighting coefficient is assigned. This is because there is a high possibility that the closer to the center, the subject is the moving body.

Note that, 1 is assigned as the weighting coefficient to a region other than the masked range 301.

Then, when the motion, in the time direction, of the feature point extracted for every frame image is recorded and the geometric calculation is performed, the tracking processing unit 82 estimates the 3D spatial structure in the image and the motion of the imaging device 2 in consideration of the weighting coefficient assigned to each feature point.

As described above, in the second example, the moving body is masked on the basis of the focus information 121 obtained by the imaging device 2, and the weighting coefficient of the feature point in the masked range 301 is reduced. As a result, a contribution degree of the feature point is reduced. Therefore, the tracking processing unit 82 can accurately execute the camera tracking processing.

Furthermore, in the computer 4, since it is not necessary to execute the processing for distinguishing between the moving body and the non-moving body, it is possible to shorten the processing time of the camera tracking processing.

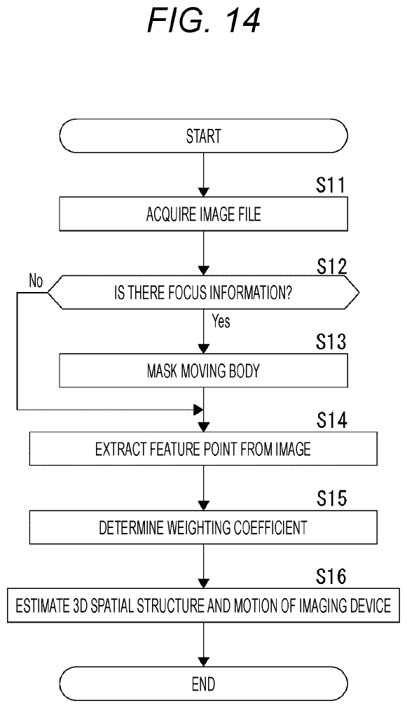

FIG. 14 is a flowchart illustrating a flow of tracking processing. As illustrated in FIG. 14, when the tracking processing is started, the data acquisition unit 81 acquires the image file 100 from the imaging device 2 in step S11.

In subsequent step S12, the tracking processing unit 82 determines whether or not the acquired image file 100 includes the focus information 121. In a case where the focus information 121 is included in the image file 100 (Yes in step S12), the tracking processing unit 82 masks a region including a subject detected as the moving body for the image 111 on the basis of the focus information 121.

Note that, in a case where the focus information 121 is not included in the image file 100 (No in step S12), the tracking processing unit 82 shifts the processing to step S14 without masking the image.

In step S14, the tracking processing unit 82 extracts a feature point from the image 111. In step S15, the tracking processing unit 82 determines a weighting coefficient for the masked range in the image 111. At this time, the tracking processing unit 82 determines the weighting coefficient such that the weighting coefficient becomes smaller toward the center.

In step S16, the tracking processing unit 82 estimates the 3D spatial structure in the image and the motion of the imaging device 2 by using the extracted feature point and the weighting coefficient, and ends the camera tracking processing.

### [3.3. Third Example of Tracking Processing]

In the first example and the second example, the imaging device 2 determines whether or not the subject is the moving body. On the other hand, in a third example, the computer 4 determines whether or not the subject is the moving body.

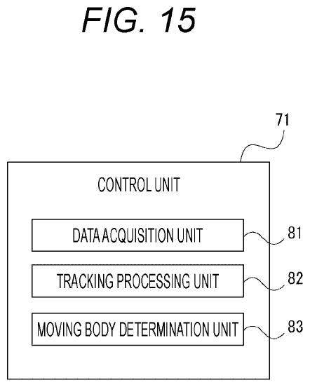

FIG. 15 is a functional block diagram of the control unit 71 in the third example. As illustrated in FIG. 17, the control unit 71 functions as a moving body determination unit 83 in addition to the data acquisition unit 81 and the tracking processing unit 82.

In the third example, the imaging device 2 detects the subject by autofocus processing, but does not determine whether or not the subject is the moving body. In this case, the body-side control unit 52 includes, in the focus information 121, subject position information indicating the position of the subject.

Furthermore, the body-side control unit 52 includes, in the focus information 121, phase difference information for every phase difference detection pixel in the imaging element 55.

Then, when the data acquisition unit 81 acquires the image file 100, the moving body determination unit 83 determines whether or not the subject is the moving body on the basis of the focus information 121 included in the image file 100, that is, the subject position information and the phase difference information.

Note that, since the determination method is similar to the method performed in the imaging device 2, and the processing after the determination as to whether or not the subject is the moving body is similar to that in the first example or the second example, the description thereof will be omitted.

As described above, in the third example, the computer 4 determines whether or not the subject is the moving body on the basis of the focus information 121. In this case, a processing load is smaller than that in a case where whether the subject is the moving body or the non-moving body is distinguished for every subject from the image 111. Therefore, even in the third example, the processing time of the camera tracking processing can be reduced.

### 4. Modifications

Note that, the embodiment is not limited to the specific examples described above, and configurations as various modifications can be adopted.

For example, the lens information may be used to determine whether or not the subject is the moving body. For example, due to the use of the zoom position, it is possible to determine whether the whole image is moving or only a part of the subject is moving.

Furthermore, in the above-described embodiment, after predetermined subjects are detected from the image, it is determined whether or not the subjects are moving bodies. However, since most of the subjects detected by the autofocus processing can be the moving bodies, it is not necessary to determine whether or not the subjects are the moving bodies after the predetermined subjects are detected from the image. Therefore, all the subjects detected from the image are treated as the moving bodies.

Even in this case, since the moving body is not extracted as the feature point, the accuracy of the camera tracking processing can be improved.

Furthermore, in the above-described embodiment, an example in which the phase difference information is used as distance information of the subject has been described, but the distance information of the subject is not limited thereto as long as the distance information of the subject is information that can obtain a distance of the subject. For example, in a case where the imaging device 2 includes a ToF sensor, a measurement value obtained by the ToF sensor may be used as the distance information.

Furthermore, in the above-described embodiment, the camera tracking processing has been described separately from the first example to the third example. Then, the computer 4 may be able to execute all of the first example to the third example, or may be able to execute only a part of the camera tracking processing.

### 5. Summary of Embodiment

As described above, the information processing apparatus (computer 4) according to the embodiment includes the acquisition unit (data acquisition unit 81) that acquires the image obtained by the imaging device 2 and the focus information 121 regarding the focus when the image is imaged, and the tracking processing unit 82 that performs the camera tracking processing on the image 111 by using the focus information 121.

Therefore, in the computer 4, the feature point can be not extracted from the range including the moving body by using the focus information, or the contribution degree of the feature point in the range can be reduced. At this time, the computer 4 does not need to distinguish the subject between the moving body and the covered body.

Thus, the computer 4 can improve the accuracy of the tracking processing while reducing the processing time.

The focus information 121 includes the information regarding the position of the subject detected in the image 111, and the tracking processing unit 82 extracts the feature point from the region excluding the range including the position of the subject indicated by the focus information 121 in the image 111, and detects the motion of the imaging device 2 on the basis of the extracted feature point.

Therefore, the computer 4 can prevent the feature point from being extracted from the range including the moving body by using the focus information.

Thus, the computer 4 can improve the accuracy of the tracking processing while reducing the processing time.

The focus information 121 includes the information regarding the position of the subject that is the moving body detected in the image 111.

Therefore, the computer 4 does not need to distinguish the subject between the moving body and the non-moving body, and the processing time can be shortened.

The tracking processing unit 82 weights the range including the position of the subject indicated in the focus information 121 and detects the motion of the imaging device.

Therefore, the computer 4 can reduce the contribution degree of the feature point in the range including the moving body, and can suppress the reduction in accuracy of the tracking processing.

Furthermore, even in a case where a region other than the range including the moving body is narrow in the image 111, the feature point can hardly be detected in the region, and the accuracy of the tracking processing is degraded unless the feature point is extracted in the range including the moving body, since the feature point is extracted in the range including the moving body, the number of extracted feature points is not reduced. Therefore, it is possible to suppress the reduction in accuracy of the tracking processing.

The tracking processing unit lowers the weighting toward the center in the range including the position of the subject indicated by the focus information 121.

Therefore, the computer 4 can lower the weighting to lower the contribution degree as it is closer to the center in the range including the position of the subject as the moving body, and can further suppress the reduction in accuracy of the tracking processing.

The focus information 121 includes the information regarding the position of the subject of the predetermined type.

The predetermined type of the subject is almost the moving body. Therefore, there is a high possibility that the subject detected by the autofocus processing in the imaging device 2 is the moving body.

Therefore, in the camera tracking processing, it is possible to accurately mask the range including the moving body by using the information regarding the position of the subject of the predetermined type.

Furthermore, in the imaging device 2, autofocus processing is often performed, and the moving body is not detected by different processing. Therefore, the processing load in the imaging device 2 does not need to be greatly increased.

The focus information includes the information regarding the position of the subject designated by the user.

There is a high possibility that the subject designated by the user is the moving body. Therefore, in the camera tracking processing, it is possible to accurately mask the range including the moving body by using the information regarding the position of the subject designated by the user.

Furthermore, in the imaging device 2, the processing load in the imaging device 2 does not need to be greatly increased.

The tracking information includes the position of the subject and the distance information (phase difference information) of the subject, and the tracking processing unit 82 determines whether or not the subject is the moving body on the basis of the distance information of the subject at the position of the subject.

Therefore, the processing load in the imaging device 2 can be further reduced.

As described above, the information processing method of the embodiment acquires the image obtained by the imaging device 2 and the focus information regarding the focus when the image is imaged, and executes the camera tracking processing on the image by using the focus information.

Furthermore, as described above, the information processing system 1 according to the embodiment includes the imaging device 2 and the information processing apparatus, the imaging device 2 includes the imaging unit (the imaging element 55) that images the second image and the first image having a lower quality than the second image, and the information processing apparatus includes the acquisition unit that acquires the image obtained by the imaging device 2 and the focus information regarding the focus when the image is imaged, and the tracking processing unit that performs the camera tracking processing on the image by using the focus information.

Note that, the effects described in the present specification are merely examples and are not limited, and other effects may be provided.

### 6. Present Technology

Note that, the present technology can also adopt the following configurations.
(1)

An information processing apparatus including:
an acquisition unit that acquires an image obtained by an imaging device and focus information regarding a focus when the image is imaged; and
a tracking processing unit that performs camera tracking processing on the image by using the focus information.
(2)

The information processing apparatus according to (1),
in which the focus information includes information regarding a position of a subject detected in the image, and
the tracking processing unit extracts a feature point from a region excluding a range including the position of the subject indicated by the focus information in the image, and detects a motion of the imaging device on a basis of the extracted feature point.
(3)

The information processing apparatus according to (1) or (2),
in which the focus information includes information regarding a position of a subject that is a moving body detected in the image.
(4)

The information processing apparatus according to (1) or (3),
in which the tracking processing unit detects a motion of the imaging device by weighting a range including a position of a subject indicated by the focus information.
(5)

The information processing apparatus according to (4),
in which the tracking processing unit lowers weighting toward a center in the range including the position of the subject indicated by the focus information.
(6)

The information processing apparatus according to any one of (1) to (5),
in which the focus information includes information regarding a position of a subject of a predetermined type.
(7)

The information processing apparatus according to any one of (1) to (6),
in which the focus information includes information regarding a position of a subject designated by a user.
(8)

The information processing apparatus according to any one of (1) to (7),
in which the focus information includes a position of a subject and distance information of the subject, and
the information processing apparatus further includes a moving body determination unit that determines whether or not the subject is a moving body on a basis of the distance information of the subject at the position of the subject.
(9)

An information processing method including:
acquiring an image obtained by an imaging device and focus information regarding a focus when the image is imaged; and
executing camera tracking processing on the image by using the focus information.
(10)

An information processing system including:
an imaging device and an information processing apparatus,
in which the imaging device includes
an imaging unit that images a subject, and
the information processing apparatus includes
an acquisition unit that acquires an image obtained by the imaging device and focus information regarding a focus when the image is imaged, and
a tracking processing unit that performs camera tracking processing on the image by using the focus information.

### REFERENCE SIGNS LIST

1 Information processing system
2 Imaging device
4 Computer
17a Motion sensor
55 Imaging element
81 Data acquisition unit
82 Tracking processing unit
83 Feature point extraction unit

1. An information processing apparatus comprising:
an acquisition unit that acquires an image obtained by an imaging device and focus information regarding a focus when the image is imaged; and
a tracking processing unit that performs camera tracking processing on the image by using the focus information.

2. The information processing apparatus according to claim 1,
wherein the focus information includes information regarding a position of a subject detected in the image, and
the tracking processing unit extracts a feature point from a region excluding a range including the position of the subject indicated by the focus information in the image, and detects a motion of the imaging device on a basis of the extracted feature point.

3. The information processing apparatus according to claim 1,
wherein the focus information includes information regarding a position of a subject that is a moving body detected in the image.

4. The information processing apparatus according to claim 1,
wherein the tracking processing unit detects a motion of the imaging device by weighting a range including a position of a subject indicated by the focus information.

5. The information processing apparatus according to claim 4,
wherein the tracking processing unit lowers weighting toward a center in the range including the position of the subject indicated by the focus information.

6. The information processing apparatus according to claim 1,
wherein the focus information includes information regarding a position of a subject of a predetermined type.

7. The information processing apparatus according to claim 1,
wherein the focus information includes information regarding a position of a subject designated by a user.

8. The information processing apparatus according to claim 1,
wherein the focus information includes a position of a subject and distance information of the subject, and
the information processing apparatus further includes a moving body determination unit that determines whether or not the subject is a moving body on a basis of the distance information of the subject at the position of the subject.

9. An information processing method comprising:
acquiring an image obtained by an imaging device and focus information regarding a focus when the image is imaged; and
executing camera tracking processing on the image by using the focus information.

10. An information processing system comprising:
an imaging device and an information processing apparatus,
wherein the imaging device includes
an imaging unit that images a subject, and
the information processing apparatus includes
an acquisition unit that acquires an image obtained by the imaging device and focus information regarding a focus when the image is imaged, and
a tracking processing unit that performs camera tracking processing on the image by using the focus information.
